(19) United States
(12) Patent Application Publication
(10) Pub. No.: US 2026/0171760 A1
(43) Pub. Date: Jun. 18, 2026

(54) COMBINED BUSHING AND INSULATOR ON TRANSFUSER

(71) Applicant: S&C Electric Company, Chicago, IL (US)

(72) Inventors: Jennifer Delgado, Chicago, IL (US); David J. Beseda, Park Ridge, IL (US); Michael R. Maroney, Chicago, IL (US)

(73) Assignee: S&C Electric Company, Chicago, IL (US)

(21) Appl. No.: 19/348,990

(22) Filed: Oct. 3, 2025

Related U.S. Application Data
(60) Provisional application No. 63/734,816, filed on Dec. 17, 2024.

(51) Int. Cl. H02B 1/18

(52) U.S. Cl. CPC H02B 1/18

(57) ABSTRACT

A fuse assembly for switchgear including a fuse, a first coupling assembly coupled to the fuse, and a second coupling assembly coupled to the fuse opposite to the first coupling assembly. The switchgear also includes an extension component extending parallel to the fuse and being coupled to the first and second coupling assemblies. The extension component includes an internal conductor electrically coupled to the second coupling assembly and a single piece insulating member molded around the conductor. The single piece insulating member includes a first cylindrical portion coupled to the first coupling assembly, a second cylindrical portion coupled to the second coupling assembly and a vertical portion coupled to the first and second cylindrical portions and being perpendicular thereto, where the conductor runs through the second cylindrical portion and the vertical portion.

### CROSS-REFERENCE TO RELATED APPLICATION

This application claims the benefit of priority from the U.S. Provisional Application No. 63/734,816, filed on Dec. 17, 2024, the disclosure of which is hereby expressly incorporated herein by reference for all purposes.

### BACKGROUND

### Field

This disclosure relates generally to electrical switchgear and, more particularly, to dead-front air insulated switchgear that includes fuse assemblies that each have a single piece molded insulating component having an internal conductor that routes the electrical power to a lower cable connection location.

### Discussion of the Related Art

An electrical power distribution network, often referred to as an electrical grid, typically includes power generation plants each having power generators, such as gas turbines, nuclear reactors, coal-fired generators, hydro-electric dams, etc. The power plants provide power at a variety of medium voltages that are then stepped up by transformers to a high voltage AC signal to be connected to high voltage transmission lines that deliver electrical power to substations typically located within a community, where the voltage is stepped down to a medium voltage for distribution. The substations provide the medium voltage power to three-phase feeders including three single-phase feeder lines that carry the same current, but are 120° apart in phase. Three-phase and/or single phase lateral lines are tapped off of the feeder that provide the medium voltage to various distribution transformers, where the voltage is stepped down to a low voltage and is provided to loads, such as homes, businesses, etc.

Power distribution networks of the type referred to above include switching devices, breakers, reclosers, interrupters, etc. that control the flow of power throughout the network. Some of these components are enclosed in external housings that are mounted on, for example, a concrete pad, or mounted underground, and are generally referred to herein as switchgear. The number and type of switchgear are application specific to the particular power network.

Live-front air insulated switchgear has been employed in these types of medium voltage power distribution networks for some time. Live-front air insulated switchgear typically include switches and fuses that are coupled to electrical cables through an open connection. The cables may extend underground through an open bottom of the switchgear, which is susceptible to vegetation and animals that may interfere with the open connection and create electrical problems. More modern dead-front air insulated switchgear that employ insulated connectors coupling the switches or fuses and the cables through various elbow connectors and soft goods are becoming the standard because of the noted advantages over live-front air insulated switchgear.

When live-front air insulated switchgear reaches the end of its life, or otherwise, it is often desirable to replace the live-front air insulated switchgear with a dead-front air insulated switchgear. However, the location where the cables are connected to the switches and fuses in the known live-front air insulated switchgear is considerably lower on the switchgear than the location where the cables are connected to the switches or fuses in the known dead-front air insulated switchgear. For example, in one specific design, the live-front air insulated switchgear switch cable terminations are roughly 25.75 inches above the support pad and the dead-front air insulated switchgear switch cable terminations are 34.25 inches above the pad in one known design. Similarly, live-front air insulated switchgear fuse terminations are 18.875 to 23.5 inches above the pad and dead-front air insulated switchgear are 38.75 inches above the pad.

Replacing live-front air insulated switchgear with dead-front air insulated switchgear is often difficult because of this difference in cable termination locations. When the cables are cut and the live-front air insulated switchgear is removed and the dead-front air insulated switchgear is put in place, the cables and other parts may need to be re-trained, re-worked, re-terminated or completely replaced to accommodate the cable attachment on the replacement switchgear. The work and materials required to reconfigure the existing cables, which may be thick, rigid and heavy, and the connector terminations to meet different termination locations on the replacement switchgear is expensive and can involve extensive work, such as replacing the concrete pads, digging up old cables and/or trenching new cables, etc.

It is sometimes possible to make up the difference in cable length in the switch compartments of the dead-front air insulated switchgear with repair T-bodies or elbow extensions, such as the known Richards Deadbreak Elbow Extension Adapter. However, reaching the fuse bushing wells in the fuse compartments of the dead-front air insulated switchgear proves challenging even when using repair or extension elbows especially when replacing live-front air insulated switchgear with horizontal fuse terminal pads.

### SUMMARY

The following discussion discloses and describes electrical switchgear. The switchgear includes a housing having a base, side panels and a top panel opposite to the base, where the base is configured to be positioned on a pad or other ground structure, and a grounded dead-front panel positioned within the housing and separating a cable compartment and a center medium voltage compartment. The switchgear further includes a plurality of fuse assemblies positioned within the center voltage compartment, where each fuse assembly includes a fuse, a lower coupling assembly coupled to the fuse, an upper coupling assembly coupled to the fuse opposite to the lower coupling assembly and an extension component extending parallel to the fuse and being coupled to the upper and lower coupling assemblies. The extension component includes a single piece molded insulating member having a lower cylindrical portion coupled to the lower coupling assembly, an upper cylindrical portion coupled to the upper coupling assembly, a vertical portion coupled to the lower and upper cylindrical portions and being perpendicular thereto and an extension portion coupled to the vertical portion opposite to the lower cylindrical portion. The extension component further includes a conductor molded within the upper cylindrical portion and the vertical portion and being electrically coupled to the upper coupling assembly. A bushing well is molded within the extension portion and is coupled to the conductor and accessible to the cable compartment. Electrical power provided to the lower coupling assembly travels up the fuse towards the top panel to the upper coupling assembly, and then travels down through the conductor towards the base to the bushing well.

Additional features of the disclosure will become apparent from the following description and appended claims, taken in conjunction with the accompanying drawings.

### BRIEF DESCRIPTION OF THE DRAWINGS

FIG. 1 is an isometric view of a dead-front air insulated switchgear positioned on a concrete pad and showing fuse cables;

FIG. 2 is a broken-away cross-sectional type side view of the switchgear shown in FIG. 1 illustrating a fuse assembly including an extension component that lowers a cable connection location of the assembly;

FIG. 3 is an isometric view of the fuse assembly separated from the switchgear;

FIG. 4 is an isometric view of the extension component separated from the fuse assembly; and

FIG. 5 is cross-sectional type side view of the extension component separated from the fuse assembly.

### DETAILED DESCRIPTION OF THE EMBODIMENTS

The following discussion of the embodiments of the disclosure directed to dead-front air insulated switchgear that includes fuse assemblies that each have a single piece molded insulating component having an internal conductor that routes the electrical power to a lower cable connection location is merely exemplary in nature, and is in no way intended to limit the invention or its applications or uses.

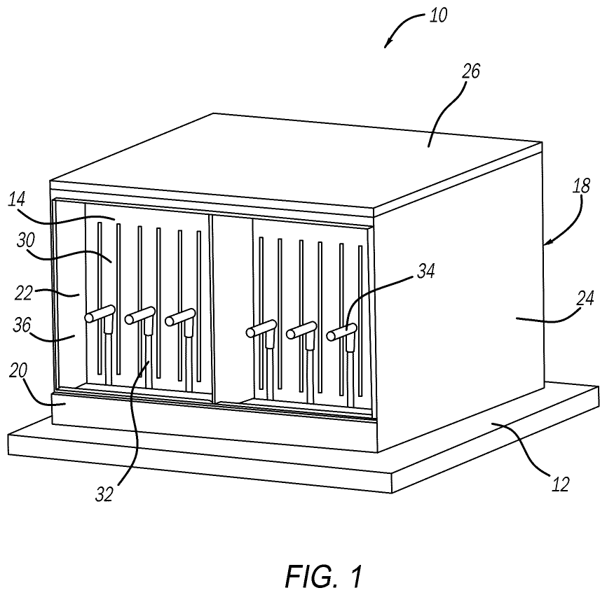

FIG. 1 is an isometric view of a dead-front air insulated switchgear 10 positioned on a concrete pad 12, where doors of the switchgear 10 have been removed to expose a grounded dead-front panel 14 at one side of the switchgear 10. For purposes of the discussion herein, the switchgear 10 is intended to represent any switchgear, pad mounted or otherwise, that includes any suitable configuration of components and devices that provide switching and disconnecting of and between one or more electrical cables coupled thereto that are part of a medium voltage electrical power distribution network. The switchgear 10 includes an outer housing 18 having a base 20 positioned on the pad 12, side panels 22 and 24 mounted to the base 20 and a top panel 26 mounted to the side panels 22 and 24.

In this non-limiting design, the switchgear 10 includes six single-phase fuse assemblies (not shown in FIG. 1) each including a channel member 30 coupled to the dead-front panel 14, where the fuse assemblies are positioned in a medium voltage compartment of the switchgear 10. Each fuse assembly is also coupled to a cable 32 through a bushing well (not shown in FIG. 1) extending through the channel member 30 by elbow connectors 34 at an outer compartment 36, where three of the fuse assemblies are at one side of the compartment 36 and three of the fuse assemblies are at the other side of the compartment 36. The switchgear 10 also includes two three-phase switches (not shown) positioned in the medium voltage compartment and being coupled to cables (not shown) by elbow connectors (not shown) through a bushing at an opposite outer compartment of the switchgear 10.

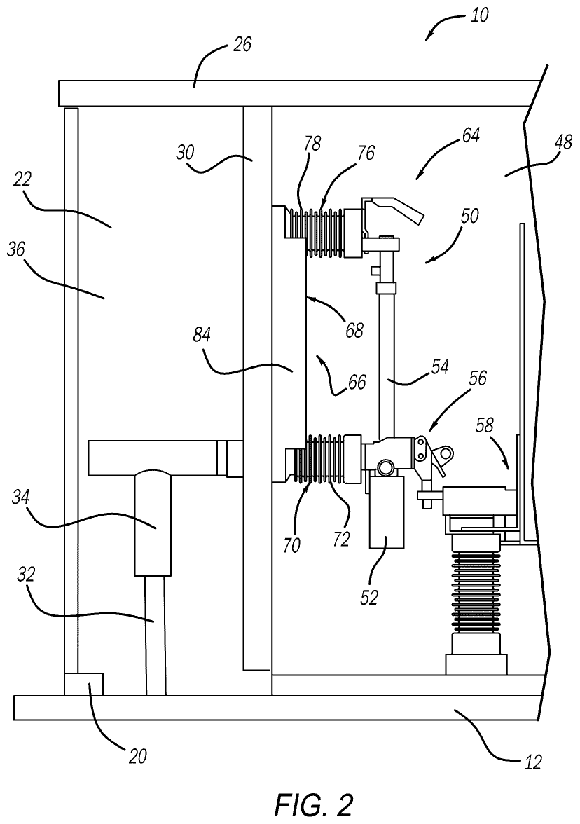

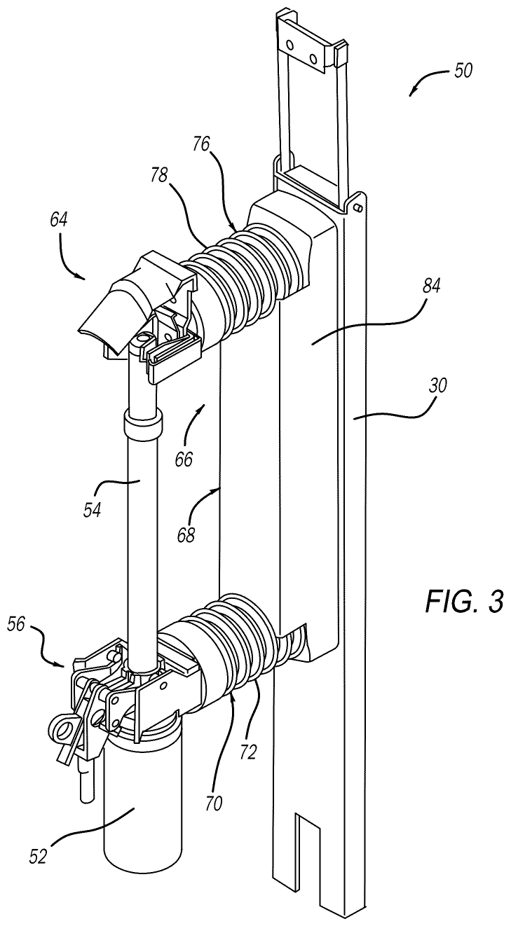

FIG. 2 is a broken-away, cross-sectional type side view of the switchgear 10 showing a fuse assembly 50 positioned within a medium voltage compartment 48 that is one of the six fuse assemblies referred to above. FIG. 3 is an isometric view of the fuse assembly 50 separated from the switchgear 10. The fuse assembly 50 includes a fuse 54 having a collection portion 52 that collects exhaust when the fuse 54 operates. The fuse assembly 50 also includes a lower coupling assembly 56 coupled to the fuse 54 and coupled to an interconnector assembly 58 that is electrically connected to one of the switches (not shown) in the compartment 48. The fuse assembly 50 also includes an upper coupling assembly 64 coupled to the fuse 54 opposite to the lower coupling assembly 56.

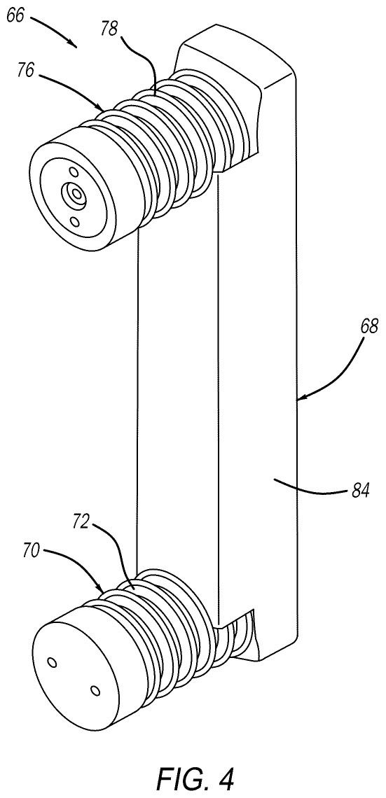

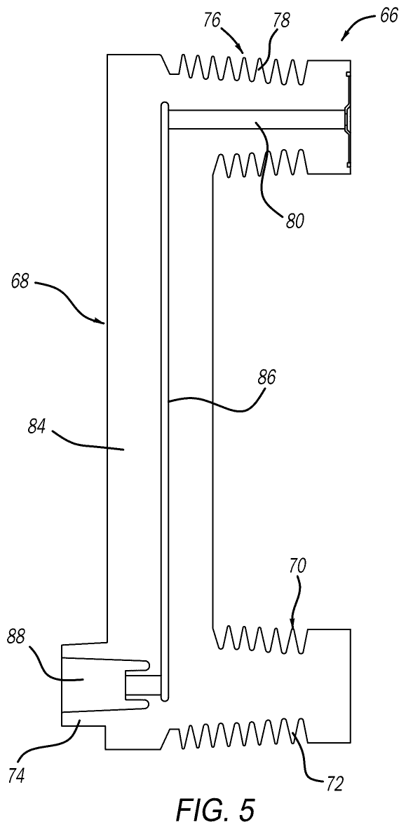

In the known designs, the upper coupling assembly 64 would be coupled to a bushing well extending through the channel member 30 at the location across from the assembly 64. However, as discussed above, this location is too high for the already existing cables to reach when live-front air insulated switchgear are replaced with dead-front air insulated switchgear. In order to address this issue, the fuse assembly 50 includes an extension component 66 that is mounted to a side of the channel member 30 facing the compartment 48 by any suitable device, such as screws (not shown). FIG. 4 is an isometric view and FIG. 5 is a cross-sectional type view of the component 66 separated from the fuse assembly 50. The component 66 includes a single piece molded member 68 made of a suitable insulating medium, such a Cypoxy™. The member 68 includes a lower transverse cylindrical portion 70 having insulator ribs 72 that operates as an insulating support piece and engages and is coupled to the lower coupling assembly 56. A cylindrical extension portion 74 of the member 68 extends opposite from the transverse portion 70. The member 68 also includes an upper transverse cylindrical portion 76 having insulator ribs 78 that is coupled to the upper coupling assembly 64, where a conductor 80 is molded within the transverse portion 76 and is electrically coupled to the assembly 64. The member 68 further includes a vertical portion 84 extending perpendicular to and between the transverse portions 70 and 76 along the channel member 30 and parallel to the fuse 54. A conductor 86 is molded within the vertical portion 84 and is electrically coupled to the conductor 80 at one end and a bushing well 88 molded within the extension portion 74 at the opposite end, where the extension portion 74 extends through the channel member 30 to expose the bushing well 88.

Thus, electrical power provided to the lower coupling assembly 56 from the interconnector assembly 58 travels up the fuse 54 to the upper coupling assembly 64 as normal so that the fuse assembly 50 does not need to be reconfigured. The electrical power then travels through the conductor 80 and down the conductor 86 to the bushing well 88 at a lower location on the channel member 30 readily accessible to the preexisting cables.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A switchgear comprising:
a housing including a base, side panels and a top panel opposite to the base, the base being configured to be positioned on a pad or other ground structure;
a grounded dead-front panel positioned within the housing and separating a cable compartment and a center voltage compartment;
at least one fuse assembly positioned within the center voltage compartment, the fuse assembly including a fuse, a lower coupling assembly coupled to the fuse, an upper coupling assembly coupled to the fuse opposite to the lower coupling assembly and an extension component extending parallel to the fuse and being coupled to the upper and lower coupling assemblies and having an internal conductor; and
a bushing well coupled to the conductor in the extension component proximate the lower coupling assembly and being accessible to the cable compartment, wherein electrical power provided to the lower coupling assembly travels up the fuse towards the top panel to the upper coupling assembly, and then travels down through the conductor towards the base to the bushing well.

2. The switchgear according to claim 1 wherein the extension component includes a lower cylindrical portion coupled to the lower coupling assembly, an upper cylindrical portion coupled to the upper coupling assembly and a vertical portion coupled to the lower and upper cylindrical portions and being perpendicular thereto, wherein the conductor runs through the upper cylindrical portion and the vertical portion.

3. The switchgear according to claim 2 wherein the lower cylindrical portion, the upper cylindrical portion and the vertical portion are a single piece molded insulating member molded around the conductor.

4. The switchgear according to claim 3 wherein the single piece molded insulating member is Cpoxy™.

5. The switchgear according to claim 3 wherein the lower and upper cylindrical portions include ribs.

6. The switchgear according to claim 3 wherein the single piece molded insulating member includes an extension portion coupled to the vertical portion opposite to the lower cylindrical portion, the bushing well being molded within the extension portion.

7. The switchgear according to claim 1 wherein the at least one fuse assembly includes a channel member mounted to the dead-front panel, the extension component being mounted to the channel member.

8. The switchgear according to claim 7 wherein the at least one fuse assembly is a plurality of fuse assemblies each being positioned within the center voltage compartment and each including a channel member mounted to the dead-front panel, a fuse, a lower coupling assembly coupled to the fuse, an upper coupling assembly coupled to the fuse opposite to the lower coupling assembly and an extension component mounted to the channel member and extending parallel to the fuse and being coupled to the upper and lower coupling assemblies and having an internal conductor.

9. The switchgear according to claim 8 wherein the plurality of fuse assemblies is six fuse assemblies.

10. The switchgear according to claim 1 wherein the electrical power provided to the lower coupling assembly is provided by a switch positioned in the center voltage compartment.

11. The switchgear according to claim 1 wherein the switchgear is a dead-front air insulated switchgear.

12. The switchgear according to claim 1 wherein the switchgear is part of a medium voltage power distribution network.

13. A fuse assembly comprising:
a fuse;
a first coupling assembly coupled to the fuse;
a second coupling assembly coupled to the fuse opposite to the first coupling assembly; and
an extension component extending parallel to the fuse and being coupled to the first and second coupling assemblies, the extension component including an internal conductor electrically coupled to the second coupling assembly and a single piece molded insulating member molded around the conductor.

14. The fuse assembly according to claim 13 wherein the single piece molded insulating member includes a first cylindrical portion coupled to the first coupling assembly, a second cylindrical portion coupled to the second coupling assembly and a vertical portion coupled to the first and second cylindrical portions and being perpendicular thereto, wherein the conductor runs through the second cylindrical portion and the vertical portion.

15. The fuse assembly according to claim 13 wherein the single piece molded insulating member is Cpoxy™.

16. The fuse assembly according to claim 13 wherein the first and second cylindrical portions include ribs.

17. The fuse assembly according to claim 13 further comprising a bushing well, wherein the single piece molded insulating member includes an extension portion coupled to the vertical portion opposite to the first cylindrical portion, the bushing well being molded within the extension portion.

18. A switchgear comprising:
a housing including a base, side panels and a top panel opposite to the base, the base being configured to be positioned on a pad or other ground structure;
a grounded dead-front panel positioned within the housing and separating a cable compartment and a center voltage compartment;
a plurality of fuse assemblies positioned within the center voltage compartment, each fuse assembly including a fuse, a lower coupling assembly coupled to the fuse, an upper coupling assembly coupled to the fuse opposite to the lower coupling assembly and an extension component extending parallel to the fuse and being coupled to the upper and lower coupling assemblies, the extension component including a single piece molded insulating member having a lower cylindrical portion coupled to the lower coupling assembly, an upper cylindrical portion coupled to the upper coupling assembly, a vertical portion coupled to the lower and upper cylindrical portions and being perpendicular thereto and an extension portion coupled to the vertical portion opposite to the lower cylindrical portion, the extension component further including a conductor molded within the upper cylindrical portion and the vertical portion and being electrically coupled to the upper coupling assembly; and
a bushing well molded within the extension portion and being coupled to the conductor and accessible to the cable compartment, wherein electrical power provided to the lower coupling assembly travels up the fuse towards the top panel to the upper coupling assembly, and then travels down through the conductor towards the base to the bushing well.

19. The switchgear according to claim 18 wherein the single piece molded insulating member is Cpoxy™.
